(19) United States
(12) Patent Application Publication
(10) Pub. No.: US 2026/0252899 A1
(43) Pub. Date: Aug. 27, 2026

(54) MULTI-AGENT CONSTRAINED DECODING

(71) Applicant: GDM Holding LLC, Mountain View, CA (US)

(72) Inventors: Florian Nils Hartmann, Zurich (CH); Victor Carbune, Zurich (CH)

(21) Appl. No.: 19/059,829

(22) Filed: Feb. 21, 2025

(51) Int. Cl. G06N 3/092; G06N 3/0475

(52) U.S. Cl. CPC G06N 3/092; G06N 3/0475

(57) ABSTRACT

Implementations described herein relate to multi-agent constrained decoding. A constraining agent participates in a dialog, receiving a stream of candidate decoded tokens from a decoding agent. The constraining agent iteratively evaluates these tokens based on decoding format constraints. Invalid tokens may trigger a rejection notice, prompting the decoding agent to stream alternatives. Valid tokens are included in a full sequence. This protocol works across diverse inference engines, using natural language communication. To improve efficiency, online training, such as parameter-efficient fine-tuning (PEFT), can be used. The method extends to multiple constraining agents, ensuring format conformance and facilitating flexible multi-agent collaboration.

### BACKGROUND

Generative models such as large language models (LLMs) and vision language models (VLMs) are increasingly used in multi-agent systems where multiple agents, each potentially powered by a different generative, collaborate to complete tasks. Effective communication and task completion often require agents to generate outputs in specific formats, such as JavaScript Object Notation (JSON) for application programming interface (API) calls or structured formats for interfacing with applications. Current constrained decoding techniques, which force generative models to produce outputs conforming to a predefined format, typically rely on shared inference engines or require extensive offline training. These approaches present significant challenges in multi-agent settings, as agents may employ different generative models and inference engines, making it difficult to share configurations or guarantee consistent format adherence across agents. Furthermore, offline training approaches are often brittle and may not generalize well to new tasks or unseen formats.

### SUMMARY

The limitations of existing techniques necessitate could be addressed by an approach that enables constrained decoding in a distributed multi-agent environment where agents communicate solely through natural language, without relying on shared inference engines or extensive offline training. This may include a mechanism for agents to negotiate and enforce format constraints dynamically during runtime, adapting to different generative models and tasks while maintaining efficiency and guaranteeing format compliance.

Implementations described herein address adapting constrained decoding techniques for generative models such as large language models (LLMs) or vision language models (VLMs) to multi-agent systems using diverse inference engines and natural language communication. Existing methods, relying on shared inference engines or heuristic training, are unsuitable. Described herein is a protocol enabling joint constrained decoding between two or more agents without shared inference engines. In various implementations, within a plurality of agents, a constraining agent and a decoding agent may be elected. The decoding agent may stream token proposals (referred to herein as "candidate decoded tokens") to the constraining agent. The constraining agent may validate the candidate decoded tokens against pre-defined decoding format constraint(s).

Decoding format constraints may take various forms, such as regular expressions, scoring functions powered by machine learning, or a combination thereof, potentially including multiple weighted scoring functions to prioritize different format aspects. Decoding format constraints might be selected based on the specific application and desired output format. For example, a regular expression could enforce a JSON structure for an API call, while a scoring function based on a machine learning model could assess semantic correctness for a natural language summary. In a calendar application, the constraint might be a regular expression matching date, time, title, and location fields.

Based on the selected decoding format constraints, the constraining agent may accept valid tokens or suggest alternatives; this iterates until a complete, valid sequence is generated. In some implementations, the number of top-k tokens and consecutive tokens streamed may be hyperparameters that are adjustable during inference. To enhance efficiency, an online training stage using parameter-efficient fine-tuning (PEFT) may allow the decoding agent to learn a profile predicting the constraining agent's preferences, minimizing rejections and communication overhead. The protocol may be extended to multiple constraining agents, possibly grouped by application, with consistency checks ensuring semantic agreement across formats. In some implementations, the constraining agent may employ proprietary evaluation criteria, maintaining confidentiality while enforcing constraints. This approach facilitates flexible multi-agent collaboration with guaranteed format conformance, even across diverse inference engines.

In various implementations, a method is implemented using one or more processors. This method may include executing a constraining agent to participate in a dialog between multiple agents, where one or more of the agents may have access to one or more generative models. The constraining agent may receive a stream of candidate decoded tokens from a decoding agent among the multiple agents. These tokens may be generated by the decoding agent using one or more of the generative models. The constraining agent may iteratively perform operations until a full sequence of valid tokens is decoded. These operations may include evaluating one or more of the candidate decoded tokens based on one or more decoding format constraints. If one or more of the candidate decoded tokens fail to satisfy one or more of the decoding format constraints, a notice of rejection may be provided to the decoding agent. This notice may cause the decoding agent to stream one or more alternative candidate decoded tokens. If one or more of the candidate decoded tokens satisfy one or more of the decoding format constraints, then those tokens may be included in the full sequence of valid tokens.

In various implementations, the one or more decoding format constraints may include one or more of a regular expression, a scoring function, or a combination thereof. The notice of acceptance may include the one or more valid candidate decoded tokens. The notice of rejection may include one or more alternative candidate decoded tokens generated by the constraining agent based on one or more of the decoding format constraints. The constraining agent may generate the one or more alternative candidate decoded tokens using one or more of the generative models. The generative model used by the constraining agent may be different from the one used by the decoding agent.

The one or more generative models may include an LLM or VLM. The one or more candidate decoded tokens may be evaluated by the constraining agent using one or more machine learning models, which may include one or more of the generative models. The notice of rejection may include a request to alter one or more hyperparameters of one or more of the generative models used by the decoding agent. One or more of these hyperparameters may include a count of top-k tokens or a count of consecutive tokens streamed. The constraining agent may conditionally incorporate the request to alter one or more hyperparameters into the notice of rejection based on a rate at which the constraining agent rejects candidate decoded tokens received from the decoding agent.

The one or more decoding format constraints may be configured to constrain the candidate decoded tokens to a given digital file format, which may include one or more of an electronic calendar entry format, an email format, a spreadsheet format, a text message format, a push notification format, a script configured to interact with one or more interactive web pages, a markup language, a markdown language, a digital image, a digital video, digital audio, or a programming language.

In various implementations, a method is implemented using one or more processors. This method may include executing a decoding agent to participate in a dialog between multiple agents, where at least the decoding agent may have access to one or more generative models. The decoding agent may generate a stream of candidate decoded tokens using one or more of the generative models and provide this stream to a constraining agent among the multiple agents. The decoding agent may iteratively perform operations until a full sequence of valid tokens is decoded. These operations may include generating and streaming one or more alternative candidate decoded tokens to the constraining agent in response to a notice of rejection. Alternatively, in response to a notice of acceptance, the one or more valid candidate decoded tokens may be included in the full sequence of valid tokens.

In various implementations, the notice of acceptance may include the one or more valid candidate decoded tokens, or the notice of rejection may include one or more alternative candidate decoded tokens generated by the constraining agent. The notice of rejection may include a request to alter one or more hyperparameters of one or more of the generative models used by the decoding agent. The decoding agent may be configured to alter the one or more hyperparameters based on the request. These hyperparameters may include a count of top-k tokens streamed by the decoding agent or a count of consecutive tokens streamed by the decoding agent. The method may further include performing PEFT on one or more learned machine learning model parameters based on the notice of rejection. The decoding agent may use one or more of the learned machine learning model parameters to generate a subsequent stream of candidate decoded tokens.

Other implementations may include a non-transitory computer readable storage medium storing instructions executable by a processor to perform a method such as one or more of the methods described above. Yet another implementation may include a control system including memory and one or more processors operable to execute instructions, stored in the memory, to implement one or more modules or engines that, alone or collectively, perform a method such as one or more of the methods described above.

In various implementations, a system may include one or more processors and memory storing instructions. Execution of these instructions may cause the one or more processors to execute a constraining agent and a decoding agent to participate in a dialog between multiple agents, where at least the decoding agent may have access to one or more generative models. The decoding agent may be configured to generate a stream of candidate decoded tokens, provide this stream to the constraining agent, and iteratively perform operations until a full sequence of valid tokens is decoded. These operations may include generating and streaming one or more alternative candidate decoded tokens to the constraining agent in response to a notice of rejection, and including the one or more valid candidate decoded tokens in the full sequence of valid tokens in response to a notice of acceptance. The constraining agent may be configured to receive the stream of candidate decoded tokens from the decoding agent, iteratively evaluate the candidate decoded tokens based on one or more decoding format constraints, and provide a notice of rejection or acceptance to the decoding agent based on the evaluation.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 shows a schematic of a multi-agent system where multiple agents communicate and collaborate to generate outputs in specific formats.

FIG. 2 illustrates a sequence diagram showing a constrained decoding session between a decoding agent and a constraining agent, including iterative token generation, evaluation, and feedback.

FIG. 3 shows a sequence diagram illustrating a constrained decoding session where the constraining agent provides alternative valid tokens upon rejection, and the decoding agent uses PEFT to improve its performance.

FIG. 4 depicts a sequence diagram illustrating a constrained decoding session involving multiple decoding agents concurrently generating parts of a shared output, coordinated by a single constraining agent.

FIG. 5 presents a flowchart outlining the operations performed by a constraining agent in the proposed multi-agent constrained decoding protocol.

FIG. 6 shows a flowchart outlining operations performed by a decoding agent in the proposed multi-agent constrained decoding protocol.

FIG. 7 illustrates a block diagram of an example computing device that may be used to implement the proposed multi-agent constrained decoding protocol.

### DETAILED DESCRIPTION

Implementations disclosed herein are directed to executing a constraining agent to participate in a dialog between multiple agents, one or more of which have access to one or more generative models. The constraining agent receives a stream of candidate decoded tokens from a decoding agent. The constraining agent selects one or more decoding format constraints based on various factors, including but not limited to agent type or task type. The constraining agent may then iteratively evaluate these tokens based on the selected decoding format constraints, providing a notice of rejection for invalid tokens and causing the decoding agent to stream alternatives, or a notice of acceptance for valid tokens to be included in a full sequence. This process continues until a full sequence of valid tokens is decoded.

Implementations disclosed herein can mitigate (e.g., eliminate) various drawbacks with current techniques. For example, the iterative evaluation of candidate tokens by the constraining agent, based on predefined format constraints, eliminates the need for shared inference engines, allowing agents with diverse generative models such as vision language models (VLMs) and/or large language models (LLMs) and inference engines to collaborate effectively. As another example, the dynamic negotiation of format constraints during runtime, through the exchange of acceptance and rejection notices, obviates the need for extensive offline training, making the system adaptable to new tasks and formats without retraining. As another example, the use of a constraining agent ensures that format constraints are consistently enforced, guaranteeing format compliance across all agents, regardless of their underlying generative models or inference engines.

As a non-limiting example of some implementations disclosed herein, consider two agents, Agent A and Agent B, collaborating to create source code that accesses external data using one or more APIs and/or database queries. Agent A, acting as the decoding agent, uses a generative model such as an LLM to generate source code that attempts to make API call(s) and/or issue database queries. Agent B, as a constraining agent, has a decoding configuration that specifies the required API format and/or database query format. Agent A streams candidate token sequences to Agent B. Agent B evaluates each sequence against its API and/or database format constraint. If a sequence is invalid (e.g., missing a required field), Agent B sends a rejection notice to Agent A. Agent A then generates and streams alternative sequences. If a sequence is valid, Agent B sends an acceptance notice, and that sequence becomes part of the final source code generated by Agent A. This iterative process continues until Agent A generates source code that is complete and accomplishes a particular goal set out by a user.

As another non-limiting example of some implementations disclosed herein, consider two agents, Agent A and Agent B, collaborating to create a calendar event. Agent A, acting as the decoding agent, uses a generative model such as an LLM to generate natural language descriptions of potential calendar events. Agent B, the constraining agent, has a decoding configuration specifying the required format for a particular type of electronic calendar entry (e.g., a regular expression matching date, time, title, and location fields). Agent A streams candidate token sequences to Agent B. Agent B evaluates each sequence against its electronic calendar format constraint. If a sequence is invalid (e.g., missing a required field), Agent B sends a rejection notice to Agent A. Agent A then generates and streams alternative sequences. If a sequence is valid, Agent B sends an acceptance notice, and that sequence becomes part of the final calendar event. This iterative process continues until Agent A generates a complete, valid electronic entry, which is then used to create the event.

In various implementations, the decoding format constraints used to check the validity of the generated text can take various forms. In some implementations, a decoding format constraint may take the form of a regular expression, a scoring function, or a combination of both. For example, a regular expression could be used to enforce a specific JavaScript Object Notation (JSON) structure, while a scoring function might assess the semantic correctness of the generated content. In some implementations, the scoring function may be implemented using a machine learning model, such as various forms of recurrent neural networks, a generative model such as a VLM or LLM, etc. In a restaurant booking scenario, the constraining agent might select a decoding format constraint that enforces a JSON structure with specific fields like restaurant name, address, date, time, and number of people. For a calendar entry, the constraint might be a regular expression matching date, time, and event description, or some file format that a specific calendar application requires. In a task involving generating few-shot examples for another agent, the constraint could be a regular expression or some formatting function(s) that map from an example to a prompt format with specific keys. If the task is to generate code in a particular programming language, the constraint could be a grammar or a linter for that language. Finally, for creating a structured report, the constraint might be a template with specific sections and formatting requirements.

In some implementations, when candidate decoded token(s) are deemed valid, the constraining agent simply sends back the valid token(s). Conversely, if a segment of candidate decoded tokens is invalid, the constraining agent can send back alternative valid decoded tokens generated by its own model (e.g., VLM or LLM), ensuring the process continues smoothly. Or, the constraining agent may generate and send back one or more demonstrations of how data is supposed to be formatted in accordance with the decoding format constraints. The constraining agent's generative model may be the same as or different from the decoding agent's generative model. For instance, one agent might use an LLM while the other uses a VLM. In some implementations, the constraining agent may use machine learning models, potentially including its own generative model, to evaluate the validity of the generated text. This allows for more sophisticated evaluation beyond simple pattern matching.

In some scenarios, the constraining agent might not only reject invalid candidate decoded tokens but also request adjustments to the decoding process parameters. These parameters may include, for instance, the number of top-k tokens considered by the constraining agent (and sent by the decoding agent) at each step, or the number of consecutive tokens streamed (e.g., a beam search width). The decision to request parameter adjustments might depend on the rejection rate; if the rejection rate is high, the constraining agent might suggest increasing the number of tokens considered to improve the chance of finding a valid option and/or reduce back and forth communication between the two agents.

Techniques described herein are capable of handling numerous different digital file formats. Non-limiting examples include calendar entries, emails, spreadsheets, text messages, push notifications, scripts for web pages, markup languages, markdown, images, videos, audio, and programming languages. This flexibility allows the system to adapt to a wide range of applications and use cases.

The techniques described herein alternatively or additionally allow constraining agents to apply proprietary and/or secret decoding format constraints on incoming candidate decoded tokens, allowing them to control the output format without divulging confidential information. The constraining agent can use a proprietary scoring function or regular expression to evaluate the validity of the tokens. This function or expression is not shared with the decoding agent; only the result (accept or reject) is communicated. In some cases there may be some algorithmic parameters put in place to avoid the non-constraining (e.g., decoding) agent to reverse engineer the private information used for the constraint based on observed rejection logic. As an example, a medical device manufacturer might use a proprietary format for patient data. The constraining agent, using a secret decoding format constraint, can ensure that only valid patient data is processed, protecting sensitive information while maintaining data integrity.

In another set of implementations, the decoding agent generates text segments and sends them to the constraining agent. Upon receiving a rejection notice, the decoding agent generates and sends alternative segments of decoded tokens. Upon receiving an acceptance notice, by contrast, the decoding agent incorporates the accepted decoded tokens into the final output. The acceptance and rejection notices can simply be the valid and invalid token(s) themselves, or they can include additional instructions, such as requests to adjust hyperparameters.

The decoding agent can also incorporate feedback from the constraining agent to improve its performance. For example, in some implementations, the decoding agent may implement parameter-efficient fine-tuning (PEFT) to train a model (e.g., a local machine learning model or Low-Rank Adaptation of Large Language Models (LoRA) weights) that better predicts the preferences of the constraining agent. This reduces the number of rejections and improves overall efficiency. PEFT profiles can be reused for other agents based on the same underlying model or performing similar applications because the PEFT profile learns to predict the constraining agent's preferences, which are largely determined by the underlying model architecture and the type of task being performed. The profile captures patterns in how the model generates valid outputs for a given format, regardless of the specific agent's other characteristics. Adding a natural language explanation of the format to the prompt further enhances reusability by providing contextual information to the PEFT profile. Alternatively, the PEFT feedback signal can be used to adjust hyperparameters such as the top-k value or the number of consecutive tokens streamed. A high rejection rate indicates the decoding agent needs more options, prompting an increase in top-k. Conversely, a low rejection rate suggests fewer tokens are needed, reducing communication overhead. This dynamic adjustment optimizes the inference process based on the learned preferences and the current performance. Alternatively to training a PEFT profile, in some implementations, an agent may create a tool (e.g., in the form of a Python script) that can be used for constraining. In various implementations, the PEFT and/or the tool (e.g., Python script) can be shared amongst multiple agents (when non-confidential) to make it easier for non-constraining agents to produce better fitting tokens.

A system can be built to facilitate this collaborative constrained decoding process. This system would include processors and memory storing instructions to manage the interaction between the constraining and decoding agents, handling the exchange of token proposals, evaluation, and feedback. The system would orchestrate the entire process, ensuring the generation of a final output that satisfies the defined constraints.

To support multiple constraining agents, in some implementations, at the beginning of the joint constrained decoding, the agents may decide on how many and which agents should be constraining. In some cases, this can be one random agent, e.g. when all agents know they want to enter data into a particular electronic calendar format, it may not matter which agent constrains the decoding to ensure the correct format. In other cases, different agents might enter the agreed information into different applications. Agents can be grouped based on the application they are interacting with. One constraining agent may then be selected per group. When there are multiple constraining agents, a consistency check can be implemented to ensure that the different decoded formats are semantically identical (or as close as possible). To do this, in some implementations, the agents may evaluate overlap of the non-constrained tokens. For instance, with calendar entries, the formal language format might be different, but the actual times and dates should be the same.

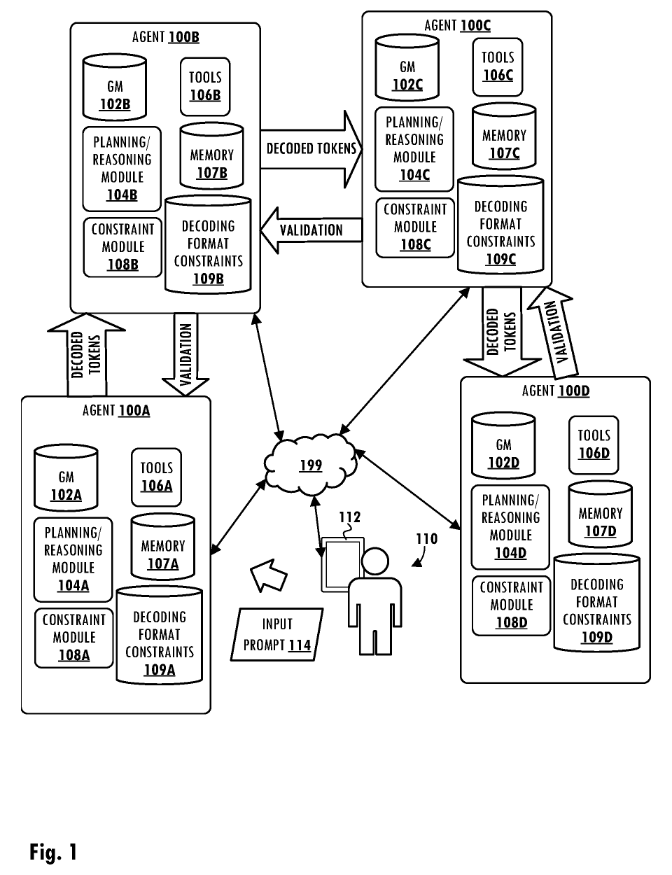

Referring now to FIG. 1, an example agentic environment in which selected aspects of the present disclosure may be implemented is depicted schematically. Each component depicted in the agentic environment of FIG. 1 may be implemented using hardware, software, firmware, or a combination thereof. A plurality of agents 100A-D are depicted in network communication with each other over one or more networks 199. Network(s) 199 may take various forms, such as one or more local or wide area networks, one or more internetworks (e.g., the Internet), etc. Each agent may be implemented using any combination of hardware and software. Agents 100A-D may be implemented across various computer systems, such as on one or more server computer systems, on a client device 112 operated by a user 110, or any combination thereof. For example, one or more of agents 100A-D may be implemented on one or computing systems that collectively form what is often referred to as a "cloud" infrastructure, or simply the "cloud." However, in many cases, all or parts of individual agents may be implemented on client device 112.

User 110 may interact with one or more agents 100A-D through client device 112. Client device 112 may take various forms, including but not limited to a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive display (e. g., a kiosk), or a wearable apparatus of the user that includes a computing device (e.g., a watch of the user having a computing device, glasses of the user having a computing device, a virtual or augmented reality system having a computing device, etc.).

Each agent 100 may include a respective generative model (GM) 102, a planning/reasoning module (RMOD) 104, tools 106, memory 107, a constraint module 108, a decoding format constraint(s) 109.

The generative models (GM) 102 can encompass a wide range of architectures, including various large language models (LLMs) and vision-language models (VLMs). LLMs, such as those based on transformer architectures (e.g., LaMDA, PaLM), can have parameter counts ranging from several billion to hundreds of billions, impacting their capabilities and computational demands. VLMs, like Flamingo or similar models integrating vision and language processing, combine image/video understanding with language generation, often employing architectures that integrate convolutional neural networks (CNNs) for visual processing with transformer-based modules for language handling. Other VLMs like Gemini are trained natively to be multimodal. The parameter count in VLMs can also vary significantly, depending on the complexity of the visual and linguistic components. Specific examples include models with tens of billions of parameters, though smaller, more efficient VLMs are also possible. The choice of GM 102 will depend on the specific application and the desired balance between performance and computational resources. For example, if a GM 102 is implemented at one or more resource-constrained devices at the "edge," e.g., on client device 112, then a generative model having a lower parameter count may be appropriate; conversely, if the GM 102 is implemented in a more accessible high-power cloud-side system, a generative model having a higher parameter count may be more effective. GM 102 may take various forms, such as encoder-decoder, encoder-decoder, encoder only, decoder-only etc. Additionally or alternatively, in some implementations, GM 102 may be used autoregressively.

The planning/reasoning module (RMOD) 104 may employ various techniques, such as symbolic reasoning, reinforcement learning, or a combination thereof, to guide the agent's actions. It may interact with the generative model 102 to generate natural language or structured data, and with the tools 106 to perform actions in the external world, such as searching the internet to perform retrieval augmented generation (RAG), interacting with application programming interfaces (APIs), controlling devices, etc. The memory 107 may store past experiences, knowledge, and intermediate results, allowing the agent 100 to learn context and adapt over time. The constraint module 108 may be used to enforce decoding format constraints 109 on the agent's actions and outputs, ensuring that they conform to specific requirements. These components may work together to enable the agent to participate in complex multi-agent interactions, effectively contributing to the overall task completion. The specific implementation details of each component may vary depending on the agent's purpose and the overall system architecture. For instance, the tools 106 may range from simple API calls to complex external programs, and the constraint module 108 may employ various techniques, such as regular expressions or machine learning models (including generative models).

Tools 106, such as APIs or custom scripts, allow the agents to interact with external systems and resources. For robot control, tools 106 could provide interfaces to robot operating systems (ROS), simulation environments (e.g., Gazebo), or hardware control interfaces. The constrained decoding techniques ensure that commands sent to these tools are in the correct format, preventing errors and ensuring reliable robot control, whether the robot is physical or simulated.

In FIG. 1, user 110 has operated client device 112 to cause an input prompt 114 to be provided to first agent 100A. The input prompt 114 can contain a variety of instructions or requests, ranging from simple commands to complex tasks requiring multi-step actions and interactions with external tools. The prompt may specify desired output formats, such as JSON, XML, or specific application-specific formats. Natural language is obtained from user 112 through various interfaces, such as text input fields, voice recognition, or natural language interfaces integrated into client device 112. The prompt's complexity and the required output format will influence the multi-agent discussion and the selection of constraining and decoding agents.

Input prompt 114 may contain various types of requests that may be suitable for handling in an agentic environment such as that depicted in FIG. 1, such as requests that will require generation of generative output that is constrained to a particular format. For example, input prompt 114 might be: "Schedule a meeting for next Tuesday between Alice, Bob, and Carol. The meeting should be for one hour and should be held in a conference room; book the room as well." First agent 100A, acting as a decoding agent for a first electronic calendar format, might generate a preliminary calendar entry based on the prompt. Second agent 100B, acting as the constraining agent for first agent 100A, would then check if the generated entry conforms to a first electronic calendar format. If not, 100B would provide feedback to 100A to correct the format. Meanwhile, second agent 100B would act as a decoding agent for a second electronic calendar format, generating an entry for Bob, with agent 100C acting as the constraining agent to ensure the format is correct. Similarly, third agent 100C would act as a decoding agent for a JSON-based file format used to book a conference room (e.g., through an API) and fourth agent 100D would act as the constraining agent for third agent 100C. This process ensures that the meeting is scheduled correctly across all three calendars and the conference room is booked, all based on a single natural language prompt.

The selection of decoding and constraining agents can be deterministic or probabilistic. Deterministic selection might assign roles based on pre-defined agent capabilities or task assignments, for example, always designating Agent A as the constraining agent for calendar events due to its specialized configuration. Probabilistic selection could randomly assign roles, ensuring fairness and distributing the computational load, or it could use a weighted probability based on factors such as agent performance history or available resources. Alternatively, agents could negotiate their roles through natural language discussion, with the agent best suited to the task (e.g., possessing the necessary format knowledge or access to specific tools) taking on the constraining role. The choice of selection method depends on the specific application and desired system properties.

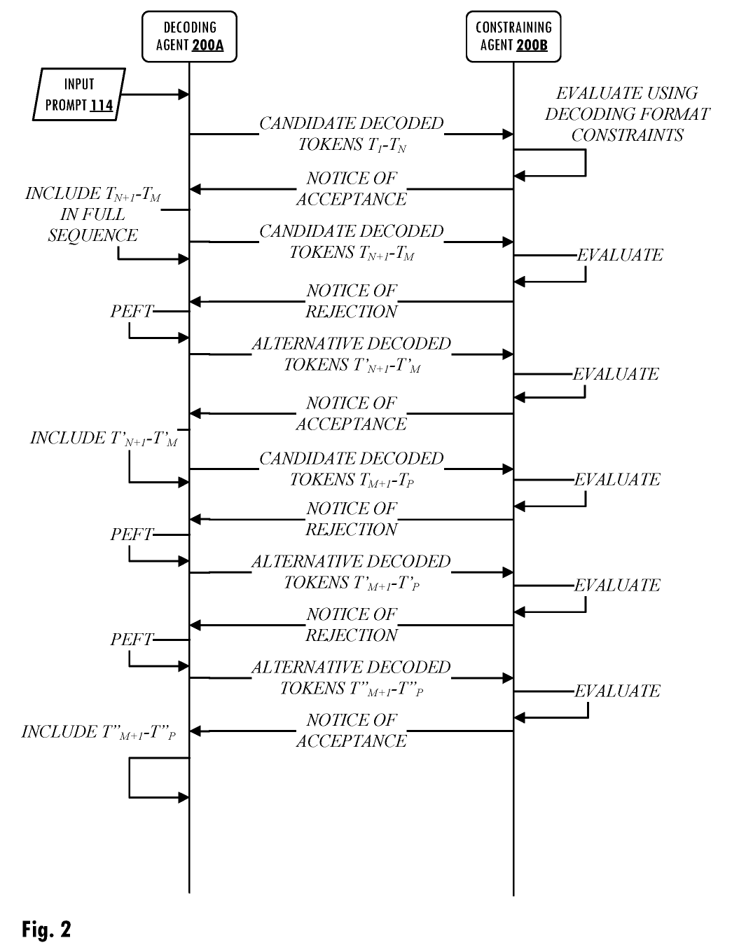

FIG. 2 schematically depicts a sequence diagram demonstrating an example constrained decoding session between a decoding agent 200A and a constraining agent 200B. In FIG. 2 and in subsequent sequence diagrams, time runs down the page. Starting at top, upon receiving an input prompt 114, decoding agent 200A may process input prompt 114 using a generative model (not depicted, 102A-D in FIG. 1) to generate candidate decoded tokens T1-TN. As shown by the arrow, decoding agent 200A may provide candidate decoded tokens T1-TN to constraining agent 200B.

Constraining agent 200B may then evaluate the candidate decoded tokens T1-TN using one or more decoding format constraints 109. Constraining agent 200B may perform this evaluation in various ways. In some implementations, this evaluation is performed using one or more machine learning models (not shown, 108A-D in FIG. 1) that is/are part of constraining agent 200A. In other implementations, constraining agent 200A may use one or more regular expressions, grammars, scoring functions, or a combination thereof, to evaluate the candidate decoded tokens T1-TN.

Based on this initial evaluation, constraining agent 200B determines that candidate decoded tokens T1-TN satisfy one or more decoding format constraints, and therefore are valid. Accordingly, in FIG. 2, constraining agent 200B sends a "notice of acceptance" message to decoding agent 200A. The notice of acceptance message may simply be an indication that the received tokens are valid, or it may include the received tokens themselves (e.g., tokens T2-TN). Whichever the case, decoding agent 200A may include valid decoded tokens T1-TN in what will eventually become the full sequence of valid decoded tokens that comply with the particular decoding format constraints being applied.

Next, decoding agent generates, and provides to constraining agent 200B, candidate decoded tokens TN+1 to TM. As shown by the arrow, constraining agent 200B may evaluate T1-TM using one or more decoding format constraint(s) 109. In some implementations, constraining agent 200B may perform this evaluation in one or more similar manners as was performed with respect to T1-TN. Based on this evaluation, constraining agent 200B determines that candidate decoded tokens T1-TM do not satisfy one or more decoding format constraints, and therefore are invalid. Consequently, constraining agent 200B sends a "notice of rejection" to decoding agent 200A. In various implementations, the notice of rejection may simply be an indication that candidate decoded tokens TN+1-TM are invalid (as is shown in FIG. 2), or it may include the invalid tokens themselves, or it may even include alternative tokens, decoded by constraining agent 200B using its own GM 102, to the invalid decoded tokens TN+1 to TM.

In some implementations, decoding agent 200A may simply try again (and as many times as necessary) to generate new tokens that comply with the decoding format constraints being used by constraining agent 200B. However, such a naive approach may consume considerable computing resources and/or network bandwidth, especially if decoding agent 200A does not "learn" from its mistake. Accordingly, in some implementations, including that depicted in FIG. 2, decoding agent 200A may perform one or more parameter-efficient fine-tuning (PEFT) processes to increase the decoding agent's 200A ability to generate valid decoded tokens. PEFT methods aim to adapt pre-trained generative models such as LLMs or VLMs to downstream tasks with minimal changes to the model's parameters, reducing computational cost and storage requirements. Several techniques achieve this, including adapter modules that insert small trainable layers into the pre-trained model, low-rank adaptation (LoRA) which updates only a small subset of the model's weight matrices, and prompt tuning which modifies the input prompt rather than the model's weights. These methods allow for faster and more efficient fine-tuning, particularly beneficial for resource-constrained environments or when adapting to numerous downstream tasks.

Next, decoding agent 200A uses its generative model 102 to generate alternative decoded tokens T'N+1 to T'M. Decoding agent 200A provides alternative decoded tokens T'N+1 to T'M to constraining agent 200B. Constraining agent 200B once again evaluates alternative decoded tokens T'N+1 to T'M using one or more decoding format constraint(s) 109. Based on this evaluation, constraining agent 200B determines that alternative decoded tokens T'N+1 to T'M satisfy one or more decoding format constraints, and therefore are valid. Consequently, constraining agent 200B sends a notice of acceptance to decoding agent 200A. The notice of acceptance message may simply be an indication that the received tokens are valid, or it may include the received tokens themselves. Decoding agent 200A then includes alternative decoded tokens T'N+1 to T'M in what will eventually become the full sequence of valid decoded tokens that comply with the particular decoding format constraints being applied.

Next, decoding agent 200A generates, and transmits to constraining agent 200B, candidate decoded tokens TM+1 to TP. As shown by the arrow, constraining agent 200B once again evaluates candidate decoded tokens TM+1 to TP using one or more decoding format constraint(s) 109. Based on this evaluation, constraining agent 200B determines that candidate decoded tokens TM+1 to TP do not satisfy one or more decoding format constraints, and therefore are invalid. Consequently, constraining agent 200B sends a notice of rejection to decoding agent 200A. The notice of rejection message may simply be an indication that candidate decoded tokens TM+1 to TP are invalid (as is shown in FIG. 2), or it may include the invalid tokens themselves, or it may even include alternative tokens, decoded by constraining agent 200B using its own GM 102, to the invalid decoded tokens TM+1 to TP.

After receiving a notice of rejection from constraining agent 200B, decoding agent 200A may employ one or more parameter- efficient fine-tuning (PEFT) processes to increase its ability to generate valid decoded tokens. Decoding agent 200A may also generate, and transmit to constraining agent 200B, alternative decoded tokens T'M+1 to T'P. In FIG. 2, constraining agent 200B determines that alternative decoded tokens T'M+1 to T'P continue to fail to satisfy one or more decoding format constraints, and therefore are also invalid. Consequently, constraining agent 200B sends another notice of rejection to decoding agent 200A, and decoding agent once again performs PEFT to improve its ability to comply with the decoding format constraints being enforced by constraining agent 200B. When the rejection rate is high, the decoding agent may adjust its top-k parameter to increase the number of tokens streamed, providing the constraining agent with more options. Alternatively, it could increase the number of consecutive tokens streamed (beam search width). The constraining agent can trigger these adjustments by explicitly requesting them in the rejection notice, or implicitly by consistently rejecting tokens, signaling the need for a broader search.

Referring back to FIG. 2, decoding agent 200A tries once more, now generating alternative decoded tokens T"M+1 to T"P. Constraining agent 200B once again evaluates alternative decoded tokens T"M+1 to T"P using one or more decoding format constraint(s) 109. Based on this evaluation, constraining agent 200B determines that alternative decoded tokens T"M+1 to T"P satisfy one or more decoding format constraints, are therefore valid, and hence sends a notice of acceptance to decoding agent 200A. Decoding agent includes alternative decoded tokens T"M+1 to T"P in what will eventually become the full sequence of valid decoded tokens that comply with the particular decoding format constraints being applied. This process may repeat until the full sequence of decoded tokens is assembled.

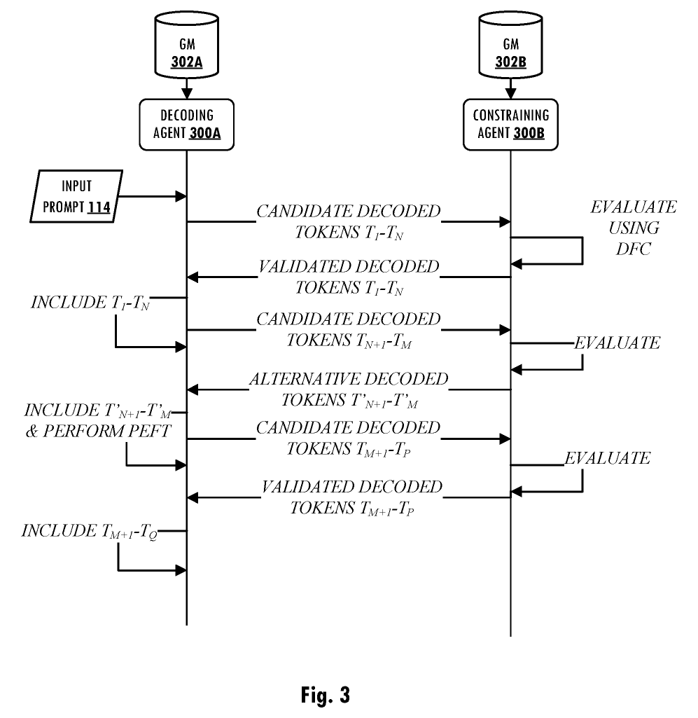

In some implementations, when constraining agents determine that candidate decoded tokens fail to satisfy decoding format constraints, they may return more than simple notices of acceptance or rejection. FIG. 3 depicts another sequence diagram in which a decoding agent 300A and a constraining agent 300B are depicted engaging in a back and forth dialog using techniques described herein. In this example, decoding agent 300A receives an input prompt 114 and generates, using its generative model 302A, a first sequence of candidate decoded tokens T1 to TN. Decoding agent 300A then provides the first sequence of candidate decoded tokens T1 to TN to constraining agent 300B.

Constraining agent 300B evaluates the first sequence of candidate decoded tokens T1 to TN using one or more decoding format constraint(s). Based on this evaluation, constraining agent 300B determines that the first sequence of candidate decoded tokens T1 to TN satisfies one or more decoding format constraints, and therefore is valid. Consequently, and instead of sending a simply acceptance message, constraining agent 300B returns the same sequence of decoded tokens T1 to TN back to decoding agent 300A. This serves as a signal to decoding agent 300A that the decoding format constraints being applied by constraining agent 300B are satisfied by the candidate decoded tokens. Consequently, decoding agent includes T1 to TN in what will eventually become a full sequence of decoded tokens.

Meanwhile, decoding agent 300A generates a second sequence of candidate decoded tokens TN+1 to TM, and sends them to constraining agent 300B. Constraining agent 300B evaluates the second sequence of candidate decoded tokens TN+1 to TM using one or more decoding format constraints. Based on this evaluation, constraining agent 300B determines that the second sequence of candidate decoded tokens TN+1 to TM does not satisfy one or more decoding format constraints, and therefore is invalid. Consequently, constraining agent 300B generates, using its own generative model 302B, an alternative sequence of tokens T'N+1 to T'M which are provided to decoding agent 300A. Decoding agent 300A may then perform PEFT method(s) to improve its abilities to generate valid decoded tokens, and may include T'N+1 to T'M in what will eventually become the full sequence of decoded tokens.

Next, decoding agent generates, and provides to constraining agent 300B, a third sequence of candidate decoded tokens TM+1 to TP. Constraining agent 300B once again evaluates the third sequence of candidate decoded tokens TM+1 to TP using one or more decoding format constraints. Based on this evaluation in this third iteration, constraining agent 300B determines that the third sequence of candidate decoded tokens TM+1 to TP satisfies one or more decoding format constraints, and therefore is also invalid. Accordingly, constraining agent 300B returns to decoding agent 300A the validated tokens TM+1 to TP. Decoding agent may then include these validated tokens TM+1 to TP in what will eventually become the full sequence of decoded tokens.

While the figures generally depict the decoding agent as assembling the final sequence of validated (i.e., properly formatted) tokens based on feedback from a respective constraining agent, this is not meant to be limiting. In some implementations, the constraining may also be involved in assembling the final sequence of validated tokens.

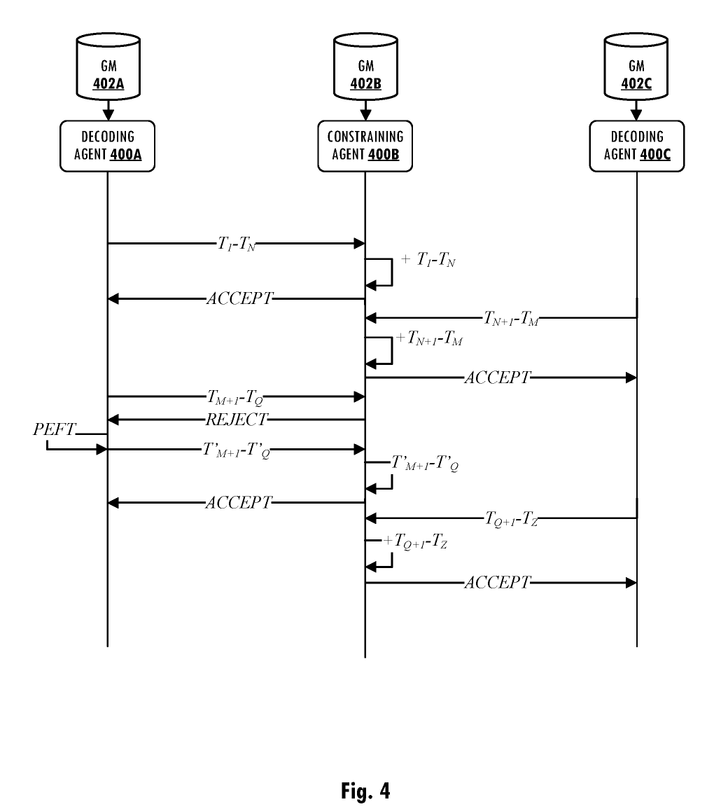

FIG. 4 depicts another sequence diagram. In this example, instead of a single decoding agent communicating with a constraining agent, the constraining agent works with multiple decoding agents at once. For example, the decoding agents may be performing parallel streaming into different parts of a shared JSON response. In some cases, the process may be driven by a single agent, e.g., the constraining agent or any of the multiple decoding agents. In FIG. 4, a first decoding agent 400A, a constraining agent 400B, and a second decoding agent 400C are depicted. Time once again runs down the page.

Starting at top, first decoding agent 400A generates using its own respective generative model 402A, and provides to constraining agent 400B, a first sequence of candidate decoded tokens T1 to TN. As in previous figures, constraining agent 400B evaluates the first sequence of candidate decoded tokens T1 to TN using one or more decoding format constraints 109A. Based on this evaluation, constraining agent 400B determines that the first sequence of candidate decoded tokens T1 to TN satisfies one or more decoding format constraints, and therefore is valid. Consequently, constraining agent 400B (rather than decoding agent 400A) includes the validated tokens T1 to TN in what will eventually become the full sequence of decoded tokens. In some implementations, valid tokens generated by first decoding agent 400A may be used to assemble a particular part of an electronic document, such as a particular area or region of a JSON, XML, or HTML file. Constraining agent 400B also sends a notice of acceptance to decoding agent in FIG. 4, but in other implementations, this step may be omitted (e.g., decoding agent 400A may determine that no feedback means the tokens it decoded were valid).

Next, second decoding agent 400C uses its own respective generative model 402C to generate, and provide to constraining agent 400B, a second sequence of candidate decoded tokens TN+1 to TM. Constraining agent 400B evaluates the second sequence of candidate decoded tokens TN+1 to TM using one or more decoding format constraint(s) . Based on this evaluation, constraining agent 400B determines that the second sequence of candidate decoded tokens TN+1 to TM satisfies one or more decoding format constraints, and therefore is valid. Consequently, constraining agent 400B includes the validated tokens TN+1 to TM in what will eventually become the full sequence of decoded tokens and sends a notice of acceptance to second decoding agent 400C.

First decoding agent 400A then uses its generative model 402A to generate, and provide to constraining agent 400B, a third sequence of candidate decoded tokens TM+1 to TQ. Constraining agent 400B once again evaluates the third sequence of candidate decoded tokens TM+1 to TQ using one or more decoding format constraint(s). This time, constraining agent 400B determines that the third sequence of candidate decoded tokens TM+1 to TQ does not satisfy one or more decoding format constraints, and therefore is invalid. Consequently, constraining agent 400B sends a notice of rejection to first decoding agent 400A. The notice of rejection message may simply be an indication that the third sequence of candidate decoded tokens TM+1 to TQ are invalid (as is shown in FIG. 4), or it may include the invalid tokens themselves, or it may even include alternative tokens, decoded by constraining agent 400B using its own generative model 402B, to the invalid decoded tokens TM+1 to TQ.

This triggers first decoding agent 400A to perform PEFT method(s) to improve its abilities to generate valid decoded tokens. Additionally, first decoding agent 400A uses its generative model 402A to generate an alternative sequence of tokens T'M+1 to T'Q. First decoding agent 400A provides the alternative sequence of tokens T'M+1 to T'Q to constraining agent 400B. Constraining agent 400B once again evaluates the alternative sequence of tokens T'M+1 to T'Q using one or more decoding format constraints. Based on this evaluation, constraining agent 400B determines that the alternative sequence of tokens T'M+1 to T'Q also satisfy one or more decoding format constraints, and therefore is valid. Consequently, constraining agent 400B includes the validated tokens T'M+1 to T'Q in what will eventually become the full sequence of decoded tokens and sends a notice of acceptance to first decoding agent 400A.

Finally, second decoding agent 400C uses its own respective generative model 402C to generate, and provide to constraining agent 400B, a fourth sequence of candidate decoded tokens TQ+1 to TZ. Constraining agent 400B once again evaluates the fourth sequence of candidate decoded tokens TQ+1 to TZ using one or more decoding format constraint(s). Based on this evaluation, constraining agent 400B determines that the fourth sequence of candidate decoded tokens TQ+1 to TZ satisfies one or more decoding format constraints, and therefore is valid. Consequently, constraining agent 400B includes the validated tokens TQ+1 to TZ in what will eventually become the full sequence of decoded tokens and sends a notice of acceptance to second decoding agent 400C.

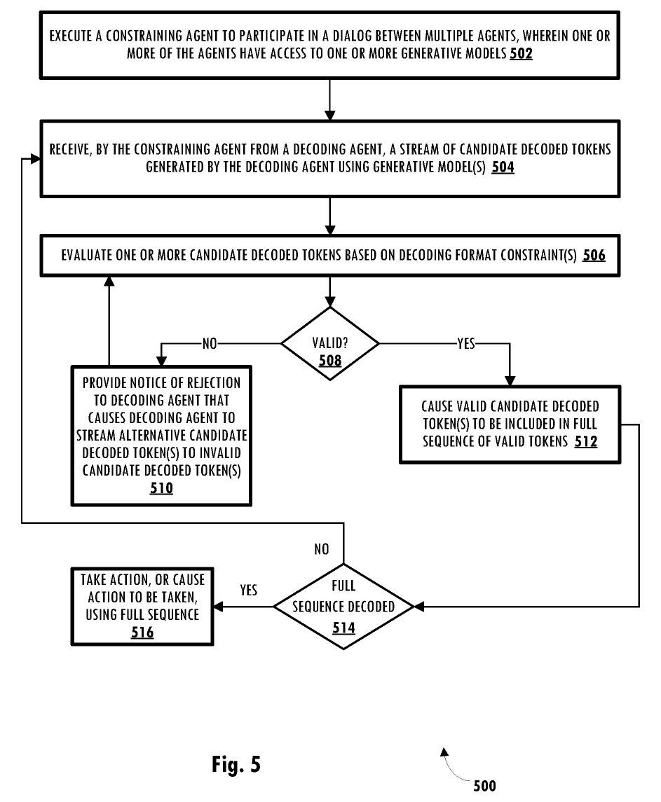

FIG. 5 schematically an example method of practicing selected aspects of the present disclosure from the perspective of a constraining agent (e.g., constraining agent 200B in FIG. 2, constraining agent 300B in FIG. 3 and constraining agent 400B in FIG. 4). For convenience, the operations of the flow chart are described with reference to a system that performs the operations. This system may include various components of various computer systems, including various components of FIG. 1. Moreover, while operations of the flow chart are shown in a particular order, this is not meant to be limiting. One or more operations may be reordered, omitted or added.

At block 502, the system may execute a constraining agent (200B, 300B, 400B) to participate in a dialog between multiple agents (e.g., 100A-D). One or more of the agents, and in many instances all of the agents, may have access to one or more generative models (102A-D). The constraining agent may be selected from the multiple agents using any suitable method, such as deterministic assignment based on agent capabilities and/or context, and/or based on probabilistic selection. For example, if the context indicates a need for a calendar entry, an agent with access to and knowledge of calendar APIs and formatting would be selected as the constraining agent. Similarly, if the task involves creating a JSON payload for a specific API, an agent proficient in JSON formatting would be chosen. In a scenario where agents are generating few-shot examples for training, the agent providing the examples would be selected as the constraining agent to ensure consistent formatting.

At block 504, the system may receive, by the constraining agent, a stream of candidate decoded tokens generated by a decoding agent (200A, 300A, 400A, 400C) using one or more of the generative models. The decoding agent may also be selected from the multiple agents using any suitable method. The candidate decoded tokens may be generated by the decoder agent using various types of generative models, such as LLMs, VLMs, diffusion models, generative adversarial networks (GANs), variational autoencoders (VAEs), flow-based models, autoregressive models, and transformer-based models.

In various implementations, the candidate decoded tokens may or may not be streamed in batches, with the number of tokens per batch being a configurable hyperparameter. Hyperparameters such as the number of top-k tokens and consecutive tokens streamed may be dynamically selected in some implementations based on the rejection rate of the constraining agent. A low rejection rate indicates high confidence in the decoding agent's output, allowing for fewer tokens to be streamed to minimize communication overhead. Conversely, a high rejection rate suggests the decoding agent needs more options, prompting an increase in the number of top-k and/or consecutive tokens streamed to improve the probability of finding a valid token. In some implementations, one or more constraining agent may decide, e.g., based on a rejection rate, that a particular decoding agent in the multi-agent dialog is not capable of outputting appropriately constrained output despite repeated back and forth with the constraining agent, that the decoding agent should be disabled. This adaptive approach optimizes communication efficiency while ensuring constraint adherence.

Referring back to FIG. 5, at blocks 506-514, the constraining agent may iteratively perform various operations until a full sequence of valid tokens is decoded. This iterative process may involve multiple rounds of token generation, evaluation, and feedback between the constraining and decoding agents. The iterative process may also include dynamic adjustment of hyperparameters , such as the number of top-k tokens or consecutive tokens streamed at each iteration, based on the rejection rate.

For instance, at block 506, the system may evaluate one or more of the candidate decoded tokens based on one or more decoding format constraints (109A-D). The decoding format constraints may include one or more of a regular expression, a scoring function, or a combination thereof. In some cases the evaluation at block 506 may involve applying a regular expression to check for syntactic correctness or using a scoring function (possibly implemented using a machine learning model) to assess semantic validity. The scoring function may, in some implementations, include multiple weighted scoring functions, allowing for prioritization of different aspects of the output format, such as syntactic correctness, semantic meaning, and adherence to specific style guidelines. For example, one scoring function might prioritize adherence to a specific JSON schema, while another might focus on the semantic coherence of the generated text. The weights assigned to each scoring function allow for fine-grained control over the relative importance of different aspects of the output format. This flexibility enables the system to adapt to a wide range of formatting requirements and ensures that the generated output meets desired standards.

At block 508, the system may determine, based on the evaluation at block 506, whether the candidate decoded tokens provided to the constraining agent by the decoding agent satisfy one or more of the decoding format constraints, and therefore are valid. If the answer is no, the method 500 may proceed to block 510. At block 510, the constraining agent may provide a notice of rejection to the decoding agent, indicating that the candidate decoded tokens do not satisfy the decoding format constraints. In some implementations, the notice of rejection may include a request to alter one or more hyperparameters of one or more of the generative models used by the decoding agent to generate the stream of candidate decoded tokens. This notice of rejection may cause the decoding agent to use its own generative model to generate, and stream to the constraining agent, one or more alternative decoded tokens. Additionally, it may cause the decoding agent to perform one or more parameter-efficient fine-tuning (PEFT) processes to increase the decoding agent's ability to generate valid tokens. Method 500 may then return to block 506, at which point the constraining agent may evaluate the newly-received alternative decoded tokens provided by the decoding agent based on the one or more decoding format constraints.

Back at block 508, if the answer is yes, then at block 512, the system may cause one or more valid candidate decoded tokens to be included in the full sequence of valid tokens. This part may be performed by the constraining agent or the decoding agent. For example, the constraining agent can cause the decoding agent to include the valid tokens in the final sequence by providing a notice of acceptance to the decoding agent. Alternatively, the constraining agent itself can assemble the final sequence of tokens.

At block 514, the system may determine whether a full sequence of tokens has been decoded. Put another way, the system may determine whether a complete response has been generated based on the content of input prompt 114. If not, method 500 may proceed back to block 504, at which point the system may receive a new stream of candidate decoded tokens, and repeat blocks 506-512. If all of the tokens have been received, method 500 may proceed to block 516, at which point the system takes action, or causes an action to be taken, using the full sequence. In many cases this may include using the fully decoded sequence, complies with the decoding format constraints, to update a document or database entry, e.g., via an API or otherwise.

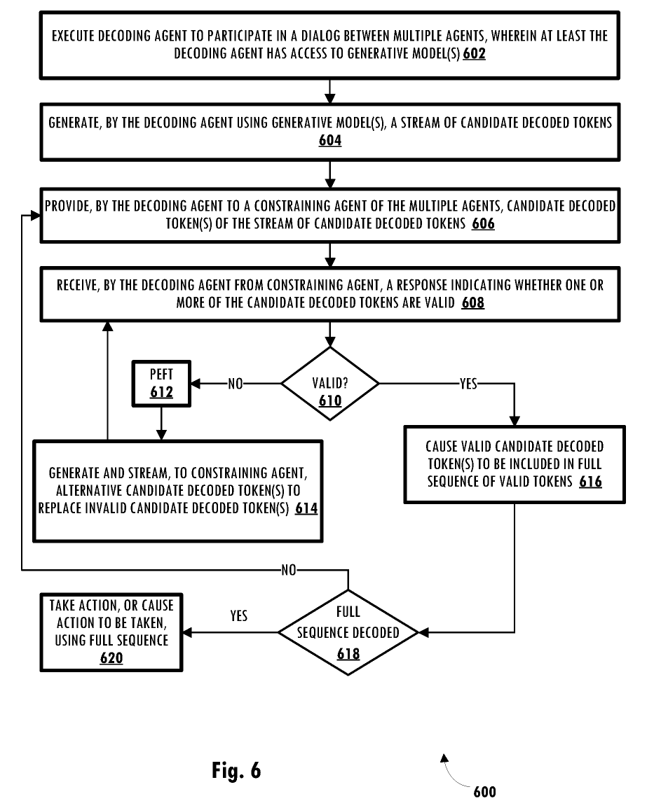

FIG. 6 depicts another method 600 for practicing selected aspects of the present disclosure from the perspective of a decoding agent (100A, 200A, 300A, 400A, 400C). For convenience, the operations of the flow chart are described with reference to a system that performs the operations. This system may include various components of various computer systems, including various components of FIG. 1. Moreover, while operations of the flow chart are shown in a particular order, this is not meant to be limiting. One or more operations may be reordered, omitted or added.

At block 602, the system may execute a decoding agent (200A, 300A, 400A, 400C) to participate in a dialog between multiple agents (e.g., 100A-D). In various implementations, at least the decoding agent, and in many cases most or all of the agents, may have access to one or more generative models (102A-D). The decoding agent may be selected from the multiple agents using any suitable method, such as deterministic assignment based on agent capabilities and/or context, and/or based on probabilistic selection.

At block 604, the decoding agent may generate a stream of candidate decoded tokens generated by the decoding agent using one or more of the generative models. The candidate decoded tokens may be generated using various types of generative models, such as LLMs, VLMs, diffusion models, GANs, VAEs, flow-based models, autoregressive models, and transformer-based models. The number of tokens per batch may be a configurable hyperparameter. At block 606, the system may provide, by the decoding agent to a constraining agent (200B, 300B, 400B) of the multiple agents, the stream of candidate decoded tokens. The constraining agent may be selected from the multiple agents using any suitable method, as described previously.

At blocks 608-618, the decoding agent may iteratively perform various operations until a full sequence of valid tokens may be decoded. This iterative process may involve multiple rounds of token generation, evaluation, and feedback between the constraining and decoding agents. For example, at block 608, the decoding agent may receive, from the constraining agent, a response indicating whether one or more of the sequence of candidate decoded tokens are valid.

At block 610, if the response indicates the token(s) are invalid, then method 600 may proceed to block 612, at which point the decoding agent may perform PEFT, as described earlier. Method 600 may then proceed to block 614. At block 614, the decoding agent may generate, and stream to the constraining agent, one or more alternative candidate decoded tokens to replace the one or more invalid candidate decoded tokens. The decoding agent may be further configured to alter the one or more hyperparameters based on the request, wherein the one or more hyperparameters may include a count of top-k tokens streamed by the decoding agent or a count of consecutive tokens streamed by the decoding agent. Method 600 may then proceed back to block 608, at which point the decoding agent may receive, from the constraining agent, another response.

Back at block 610, if the response received by the decoding agent from the constraining agent indicates the candidate decoded tokens streamed by the decoding agent were valid, then method 600 may proceed to block 616. At block 616, the system may cause the one or more valid candidate decoded tokens to be included in the full sequence of valid tokens. The decoding agent may, in some implementations, assemble the final sequence of tokens itself, while in other implementations, the constraining agent may assemble the final sequence of tokens. Method may then proceed to block 618 to determine whether a full sequence of valid tokens has been decoded (i.e. whether a complete response has been generated based on the content of input prompt 114). If the answer is no, then method 600 may proceed to block 606, at which point another stream of candidate decoded tokens may be generated and provided to the constraining agent. If the answer at block 618 is yes, however, then at block 620, the system may take action, or cause an action to be taken, using the full sequence of valid tokens.

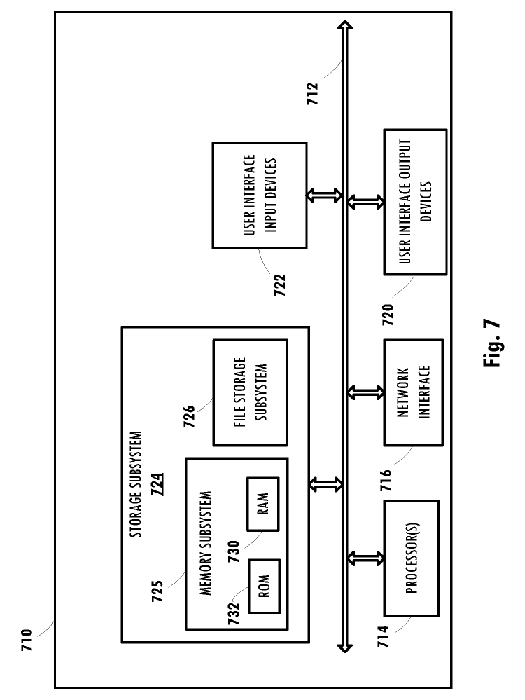

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, virtual reality or augmented reality lenses, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of method 500 and/or method 600.

These software modules are generally executed by processor 714 alone or in combination with other processors. Processor 714 may take various forms, such as one or more central processing units (CPUs), graphics processing units (GPUs), tensor processing units (TPUs), neural processing units (NPUs), digital signal processors (DSPs), field-programmable gate arrays (FPGAs), application-specific integrated circuits (ASICs), and/or coarse-grained reconfigurable architectures (CGRAs).

Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple busses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In this specification, the term "configured" is used in relation to computing systems and environments, as well as computer program components. A computing system or environment is considered "configured" to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are "configured" to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term "computing device or hardware" refers to the physical components involved in data processing and encompasses all types of devices and machines used for this purpose. Examples include processors or processing units,, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term "engine" broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. These processes and logic flows can be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can utilize any type of central processing unit (CPU) graphics processing units (GPUs), tensor processing units (TPUs), and other machine learning accelerators. GPUs, TPUs, and other machine learning accelerators may be employed to enhance performance, particularly for tasks involving artificial intelligence and machine learning. These accelerators may work in conjunction with CPUs, handling specialized computations while the CPU manages overall system operations and other tasks. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors, comprising:
executing a constraining agent to participate in the dialog between multiple agents, wherein one or more of the agents have access to one or more generative models;
receiving, by the constraining agent from a decoding agent of the multiple agents, a stream of candidate decoded tokens generated by the decoding agent using one or more of the generative models;
iteratively performing, by the constraining agent, the following operations until a full sequence of valid tokens is decoded:
evaluating one or more of the candidate decoded tokens based on one or more decoding format constraints;
upon determining, based on the evaluating, that one or more of the candidate decoded tokens fail to satisfy one or more of the decoding format constraints and are thereby invalid, providing a notice of rejection to the decoding agent that causes the decoding agent to stream one or more alternative candidate decoded tokens to the one or more invalid candidate decoded tokens;
upon determining, based on the evaluating, that one or more of the candidate decoded tokens satisfy one or more of the decoding format constraints and are thereby valid, causing one or more valid candidate decoded tokens to be included in the full sequence of valid tokens.

2. The method of claim 1, wherein the one or more decoding format constraints comprise one or more of a regular expression, a scoring function, or combination thereof.

3. The method of claim 1, wherein the notice of rejection comprises one or more demonstrations associated with the decoding format constraints.

4. The method of claim 1, wherein the notice of rejection comprises one or more alternative candidate decoded tokens generated by the constraining agent based on one or more of the decoding format constraints.

5. The method of claim 4, wherein the constraining agent generates the one or more alternative candidate decoded tokens using one or more of the generative models.

6. The method of claim 5, wherein the generative model used by the constraining agent to generate the one or more alternative candidate decoded tokens comprises a different generative model that the one used by the decoding agent to generate the one or more candidate decoded tokens.

7. The method of claim 1, wherein the one or more generative models comprise a large language model (LLM) or vision language model (VLM).

8. The method of claim 1, wherein the one or more candidate decoded tokens are evaluated by the constraining agent using one or more machine learning models.

9. The method of claim 8, wherein the one or more machine learning models comprise one or more of the generative models.

10. The method of claim 1, wherein the notice of rejection comprises a request to alter one or more hyperparameters of one or more of the generative models used by the decoding agent to generate the stream of candidate decoded tokens.

11. The method of claim 10, wherein one or more of the hyperparameters comprises a count of top-k tokens.

12. The method of claim 10, wherein one or more of the hyperparameters comprises a count of consecutive tokens streamed.

13. The method of claim 10, wherein the constraining agent conditionally incorporates the request to alter one or more hyperparameters into the notice of rejection based on a rate at which the constraining agent rejects candidate decoded tokens received from the decoding agent.

14. The method of claim 1, wherein one or more of the decoding format constraints are configured to constrain the candidate decoded tokens to a given digital file format.

15. The method of claim 14, wherein the digital file format comprises one or more of an electronic calendar entry format, an email format, a spreadsheet format, a text message format, a push notification format, a script configured to interact with one or more interactive web pages, a markup language, a markdown language, a digital image, a digital video, digital audio, or a programming language.

16. A method implemented using one or more processors, comprising:
executing a decoding agent to participate in a dialog between multiple agents, wherein at least the decoding agent has access to one or more generative models;
generating, by the decoding agent, a stream of candidate decoded tokens generated by the decoding agent using one or more of the generative models;
providing, by the decoding agent to a constraining agent of the multiple agents, the stream of candidate decoded tokens;
iteratively performing, by the decoding agent, the following operations until a full sequence of valid tokens is decoded:
in response to a notice of rejection from the constraining agent that one or more of the candidate decoded tokens fail to satisfy one or more decoding format constraints and thereby is invalid, generating, and streaming to the constraining agent, one or more alternative candidate decoded tokens to the one or more invalid candidate decoded tokens;
in response to a notice of acceptance from the constraining agent that one or more of the candidate decoded tokens satisfy one or more of the decoding format constraints and thereby is valid, including the one or more valid candidate decoded tokens in the full sequence of valid tokens.

17. The method of claim 16, wherein:
the notice of acceptance comprises the one or more valid candidate decoded tokens; or
the notice of rejection comprises one or more alternative candidate decoded tokens generated by the constraining agent based on one or more of the decoding format constraints.

18. The method of claim 16, wherein the notice of rejection comprises a request to alter one or more hyperparameters of one or more of the generative models used by the decoding agent to generate the stream of candidate decoded tokens, and the decoding agent is further configured to alter the one or more hyperparameters based on the request, wherein the one or more hyperparameters comprise a count of top-k tokens streamed by the decoding agent or a count of consecutive tokens streamed by the decoding agent.

19. The method of claim 16, further comprising:
performing parameter-efficient fine-tuning (PEFT) on learned machine learning model parameters based on the notice of rejection; and
using, by the decoding agent, one or more of the learned machine learning model parameters to generate a subsequent stream of candidate decoded tokens.

20. A system comprising one or more processors and memory storing instructions that, in response to execution of the instructions by the one or more processors, cause the one or more processors to:
execute a constraining agent and a decoding agent to participate in a dialog between multiple agents, wherein at least the decoding agent has access to one or more generative models;
wherein the decoding agent is configured to:
generate a stream of candidate decoded tokens generated by the decoding agent using one or more of the generative models;
providing, to the constraining agent, the stream of candidate decoded tokens;
iteratively perform the following operations until a full sequence of valid tokens is decoded:
in response to a notice of rejection from the constraining agent that one or more of the candidate decoded tokens fail to satisfy one or more decoding format constraints and thereby is invalid, generate, and streaming to the constraining agent, one or more alternative candidate decoded tokens to the one or more invalid candidate decoded tokens; and
in response to a notice of acceptance from the constraining agent that one or more of the candidate decoded tokens satisfy one or more of the decoding format constraints and thereby is valid, cause the one or more valid candidate decoded tokens to be included in the full sequence of valid tokens; and
wherein the constraining agent is configured to:
receive, from the decoding agent, the stream of candidate decoded tokens generated by the decoding agent;
iteratively perform the following operations until the full sequence of valid tokens is decoded:
evaluate one or more of the candidate decoded tokens based on one or more of the decoding format constraints;
in response to a determination, based on the evaluation, that one or more of the candidate decoded tokens fail to satisfy one or more of the decoding format constraints and are thereby invalid, provide a notice of rejection to the decoding agent;
in response to a determination, based on the evaluation, that one or more of the candidate decoded tokens satisfy the decoding format constraints and are thereby valid, provide a notice of acceptance to the decoding agent.
